(19) United States
(12) Patent Application Publication
(10) Pub. No.: US 2025/0386072 A1
(43) Pub. Date: Dec. 18, 2025

(54) VIDEO STREAM MANAGEMENT METHOD, VIDEO STREAM MANAGEMENT SYSTEM, AND VIDEO STREAM MANAGEMENT DEVICE

(71) Applicant: Panasonic Intellectual Property Management Co., Ltd., Osaka (JP)

(72) Inventors: Yuki NATSUKAWA, Osaka (JP); Yoshinori OKAZAKI, Osaka (JP); Osafumi MORIYA, Osaka (JP); Shin'ya TAKEDA, Osaka (JP)

(21) Appl. No.: 18/834,094

(22) PCT Filed: Mar. 1, 2023
(86) PCT No.: PCT/JP2023/007556

§ 371 Date: Mar. 25, 2025

(30) Foreign Application Priority Data
Mar. 7, 2022 (JP) 2022-034715

(51) Int. Cl. H04N 21/431; H04N 21/858

(52) U.S. Cl. CPC H04N 21/4318; H04N 21/8586

(57) ABSTRACT

A video stream management method executed by a video stream management system that manages a video stream received from a video source, the method including: accepting editing of a predetermined portion in a distribution URL set to the video source; receiving a distribution URL having the predetermined portion edited and the video stream from the video source; and displaying a description of the predetermined portion together with the video stream.

### BACKGROUND

### 1. Technical Field

The present disclosure relates to a video stream management method for managing a video stream received from a video source, and the like.

### 2. Description of the Related Art

Patent Literature 1 discloses a technique for converting a communication protocol for realizing live distribution between incompatible clients and a server.

### CITATION LIST

### Patent Literature

PTL 1: Unexamined Japanese Patent Publication No. 2020-123086

### SUMMARY

In the technology disclosed in Patent Literature 1, a user who has seen a distributed video stream cannot specify a transmission source of the video stream, and for example, cannot determine whether the video stream is reliable.

Therefore, the present disclosure provides a video stream management method and the like that enable a user to specify a transmission source of a video stream.

A video stream management method according to the present disclosure is a video stream management method executed by a video stream management system that manages a video stream received from a video source, the method including: accepting editing of a predetermined portion in a distribution URL set to the video source; receiving a distribution URL having the predetermined portion edited and the video stream from the video source; and displaying a description of the predetermined portion together with the video stream.

A video stream management system according to the present disclosure is a video stream management system that manages a video stream received from a video source, the system including: an acceptance unit that accepts editing of a predetermined portion in a distribution URL set to the video source; a reception unit that receives a distribution URL having the predetermined portion edited and the video stream; and a display unit that displays a description of the predetermined portion together with the video stream.

A video stream management method according to the present disclosure is a video stream management method executed by a video stream management device that manages a video stream received from a video source, the method including: receiving a distribution URL set to the video source and the video stream, the distribution URL having a predetermined portion edited; and displaying a description of the predetermined portion together with the video stream.

A video stream management device according to the present disclosure is a video stream management device that manages a video stream received from a video source, the device including: a reception unit that receives a distribution URL set to the video source and the video stream, the distribution URL having a predetermined portion edited; and a display unit that displays a description of the predetermined portion together with the video stream.

According to the video stream management method and the like of the present disclosure, the user can specify a transmission source of the video stream.

### BRIEF DESCRIPTION OF THE DRAWINGS

FIG. 1 is a diagram illustrating an example of a configuration of a video stream management system according to an exemplary embodiment.

FIG. 2 is a view illustrating an example of a distribution URL editing screen.

FIG. 3 is a view illustrating an example of a URL list.

FIG. 4A is a view illustrating an example of a display screen of an edited distribution URL.

FIG. 4B is a view illustrating an example of a display screen of an edited distribution URL.

FIG. 4C is a view illustrating an example of a display screen of an edited distribution URL.

FIG. 5 is a sequence diagram illustrating an example of a video stream management method according to the exemplary embodiment.

FIG. 6 is a sequence diagram illustrating an example of a video stream management method according to the exemplary embodiment,

FIG. 7 is a view illustrating an example of a display screen of a video stream in the exemplary embodiment.

FIG. 8 is a flowchart illustrating an example of an operation at the time of accepting editing of a distribution URL of a stream server according to the exemplary embodiment.

FIG. 9 is a flowchart illustrating an example of an operation at the time of receiving a distribution URL of the stream server according to the exemplary embodiment.

FIG. 10 is a sequence diagram illustrating an example of a video stream management method according to a modification of the exemplary embodiment.

FIG. 11 is a view illustrating an example of a display screen of a video stream in the modification of the exemplary embodiment.

FIG. 12 is a flowchart illustrating an example of an operation at the time of receiving a distribution URL of a stream server according to a modification of the exemplary embodiment.

### DETAILED DESCRIPTION

Hereinafter, an exemplary embodiment will be described in detail with reference to the drawings as appropriate. It is noted that a more detailed description than necessary may be omitted. For example, a detailed description of a well-known matter and a repeated description of substantially the same configuration may be omitted. This is to avoid unnecessary redundancy of the following description and to facilitate understanding of those skilled in the art.

Note that the inventor provides the accompanying drawings and the following description in order for those skilled in the art to fully understand the present disclosure, and does not intend to limit the subject matter described in the claims by the accompanying drawings and the following description.

### EXEMPLARY EMBODIMENTS

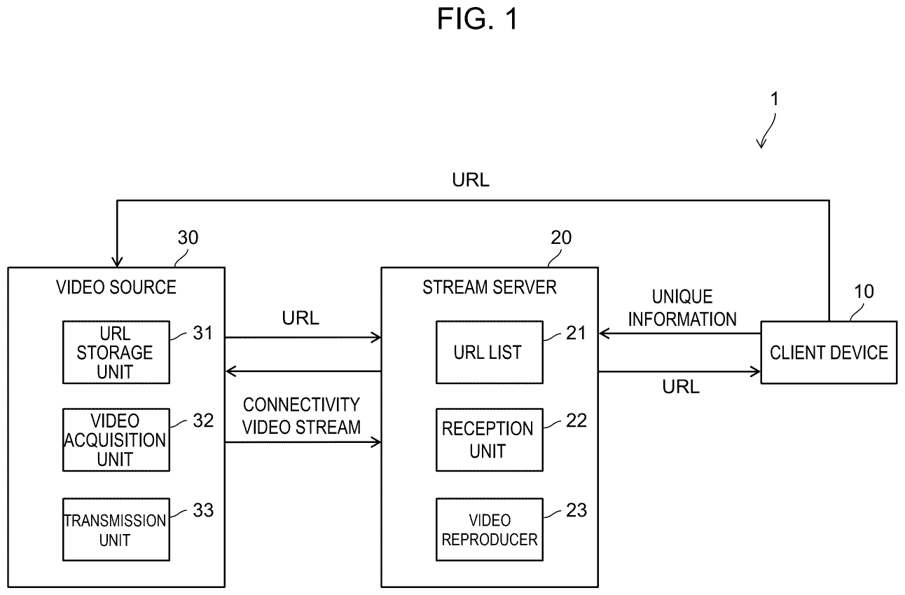

An exemplary embodiment will be described with reference to FIGS. 1 to 9.

FIG. 1 is a diagram illustrating an example of a configuration of video stream management system 1 according to an exemplary embodiment.

Video stream management system 1 is a system that manages a video stream received from video source 30. Video source 30 is, for example, a device having a memory in which a video is stored, a camera that captures a video, or the like. Video stream management system 1 includes client device 10, stream server 20, and video source 30.

Client device 10 is a device operated by a user who views a distributed video stream, and is communicably connected to, for example, stream server 20 and video source 30. For example, a streaming distribution application is installed in client device 10, and communication with stream server 20 and video source 30 is performed via the distribution application. Client device 10 accepts editing of a predetermined portion in the distribution URL (hereinafter, also referred to as URL) set to video source 30. Client device 10 is an example of an acceptance unit. The URL is used when a video stream is distributed, and includes an IP address, an ID, and the like of stream server 20. For example, the user edits a predetermined portion of the URL via client device 10, and inputs information unique to video source 30 to the predetermined portion. For example, the information unique to video source 30 is a nickname or the like of video source 30 recognized by the user.

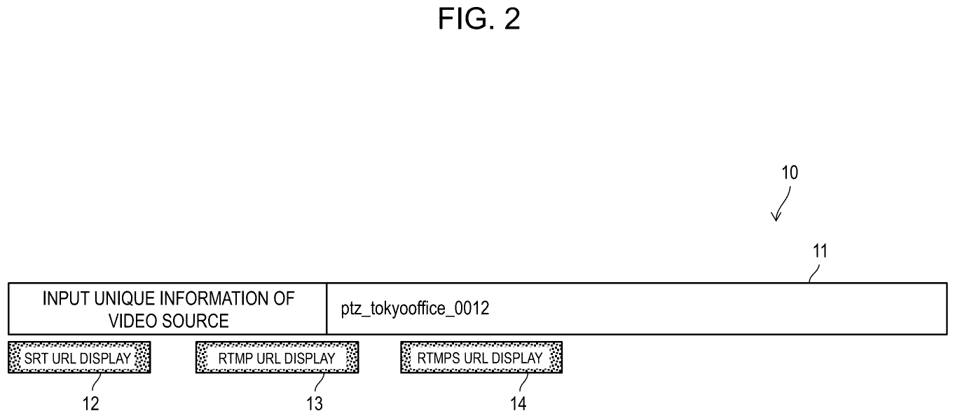

FIG. 2 is a diagram illustrating an example of a URL editing screen.

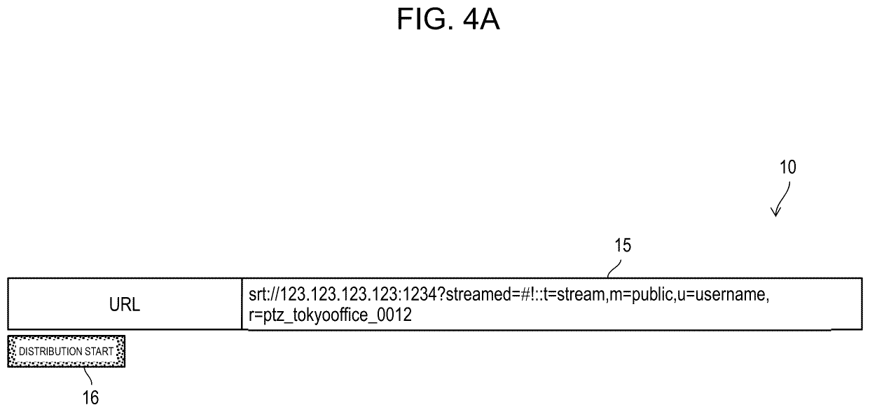

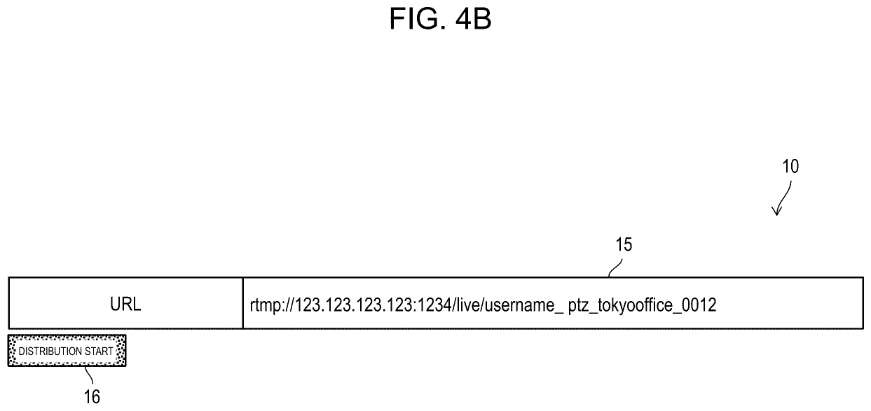

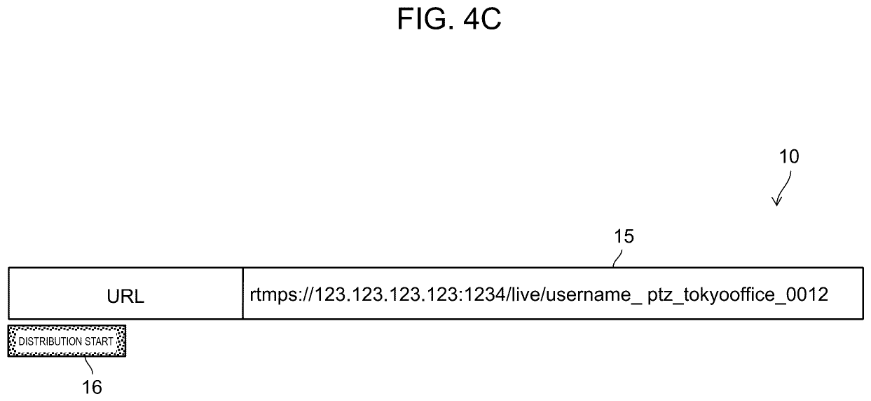

When the user inputs unique information using client device 10, client device 10 accepts editing of a predetermined portion in the URL. FIG. 2 illustrates input field 11 to which unique information is input, displayed on a display device such as a display of client device 10. Then, the user operates URL display button 12, 13, or 14 to display the URL having a predetermined portion edited on a display or the like of client device 10 (see FIGS. 4A to 4C to be described later).

URL display button 12 is a button for causing stream server 20 to generate a URL corresponding to an SRT protocol and causing client device 10 to display the generated URL. URL display button 13 is a button for causing stream server 20 to generate a URL corresponding to an RTMP protocol and causing client device 10 to display the generated URL. URL display button 14 is a button for causing stream server 20 to generate a URL corresponding to an RTMPS protocol and causing client device 10 to display the generated URL.

Stream server 20 is a distribution server that performs streaming distribution of a video via a network, and can perform reproduction at the same time while downloading a file. Stream server 20 is an example of a video stream management device that manages a video stream received from video source 30. Stream server 20 includes URL list 21, reception unit 22, and video reproducer 23. Stream server 20 acquires the unique information input to client device 10, and generates a URL having a predetermined portion edited corresponding to the communication protocol (for example, SRT protocol, RTMP protocol, or RTMPS protocol) selected by the user.

URL list 21 is a list in which the generated URLs are associated with unique information. Stream server 20 generates a URL, and stores the generated URL in URL list 21 in association with the unique information.

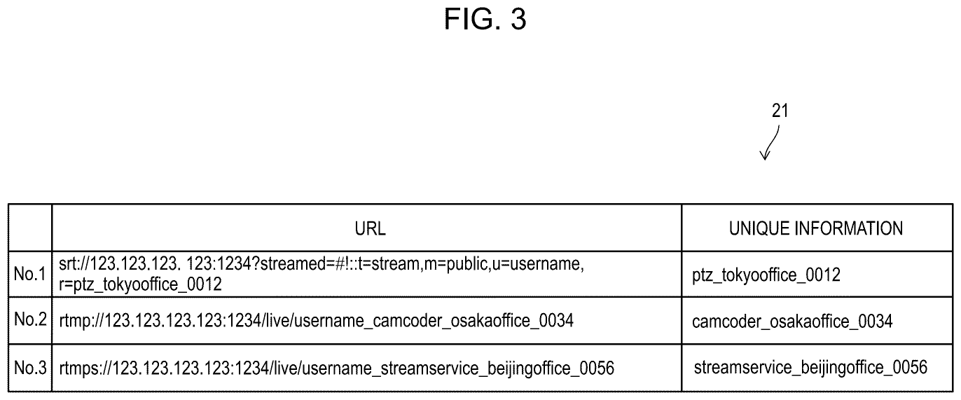

FIG. 3 is a diagram illustrating an example of URL list 21.

For example, “ptz_tokyooffice_0012” is input as unique information, and a URT “srt://123.123.123.123:1234?streamed= #!:: t=stream, m=public, u-username, r=ptz_tokyooffice_0012” corresponding to the SRT protocol is generated and stored in URL list 21. The predetermined portion in the URL is a portion after “r=”.

For example, “camcoder_osakaoffice_0034” is input as unique information, and a URL “rtmp://123.123.123.123: 1234/live/username_camcoder_osakaoffice_0034” corresponding to the RTMP protocol is generated and stored in URL list 21. The predetermined portion in the URL is a portion after “username

For example, “streamservice_beijingoffice_0056” is input as unique information, and a URL “rtmps://123.123.123.123: 1234/live/usemame_streamservice_beijingoffice_0056” corresponding to the RTMPS protocol is generated and stored in URL list 21. The predetermined portion in the URL is a portion after “username

Note that stream server 20 may generate a URL for each communication protocol for the acquired one piece of unique information and store the URL in URL list 21. For example, “ptz_tokyooffice_0012” may be input as unique information, and a URL “srt://123.123.123.123:1234?streamed= #!:: t=stream, m=public, u=username, r=ptz_tokyooffice_0012” corresponding to the SRT protocol, a URL “rtmp://123.123.123.123: 1234/live/username_ptz_tokyooffice_0012” corresponding to the RTMP protocol, and a URL “rtmps://123.123.123.123: 1234/live/username_ptz_tokyooffice_0012” corresponding to the RTMPS protocol may be generated and stored in URL list 21.

The URL obtained by editing the generated predetermined portion is transmitted to client device 10 and displayed on a display or the like of client device 10.

FIGS. 4A to 4C are diagrams illustrating an example of a display screen of an edited URL,

FIG. 4A illustrates display field 15 in which the URL corresponding to the SRT protocol is displayed, FIG. 4B illustrates display field 15 in which the URL corresponding to the RTMP protocol is displayed, and FIG. 4C illustrates display field 15 in which the URL corresponding to the RTMPS protocol is displayed. When URL display button 12 illustrated in FIG. 2 is operated, the URL in display field 15 in FIG. 4A is displayed. When URL display button 13 illustrated in FIG. 2 is operated, the URL in display field 15 in FIG. 4B is displayed. When URL display button 14 illustrated in FIG. 2 is operated, the URL in display field 15 in FIG. 4C is displayed. Note that the URL display button for each communication protocol may not be provided, and all the URLs corresponding to each communication protocol may be displayed.

Then, the user operates distribution start button 16 to set the displayed URL to video source 30, and the video stream is distributed from video source 30. Note that, in a case where video source 30 is not communicably connected to client device 10, the user may manually input the displayed URL to video source 30 and set the URL to video source 30. For example, in a case where video source 30 is a camera that is not communicably connected to client device 10, the URL may be manually input to video source 30 via a user interface or the like of the camera.

Reception unit 22 receives the URL having the predetermined portion edited and the video stream from video source 30.

Video reproducer 23 reproduces the received video stream, and displays the description of the predetermined portion of the URL together with the video stream. Video reproducer 23 is an example of the display unit.

Video source 30 includes URL storage unit 31, video acquisition unit 32, and transmission unit 33.

URL storage unit 31 stores the URL set by the user.

Video acquisition unit 32 acquires a video. When video source 30 is a camera, video acquisition unit 32 acquires a video captured by the camera. In a case where video source 30 is a device having a memory in which a video is stored, video acquisition unit 32 acquires the video from the memory. Furthermore, in a case where video source 30 has a function of capturing a screen, video acquisition unit 32 acquires an image obtained by capturing the screen.

Transmission unit 33 transmits the URL and the video stream to stream server 20.

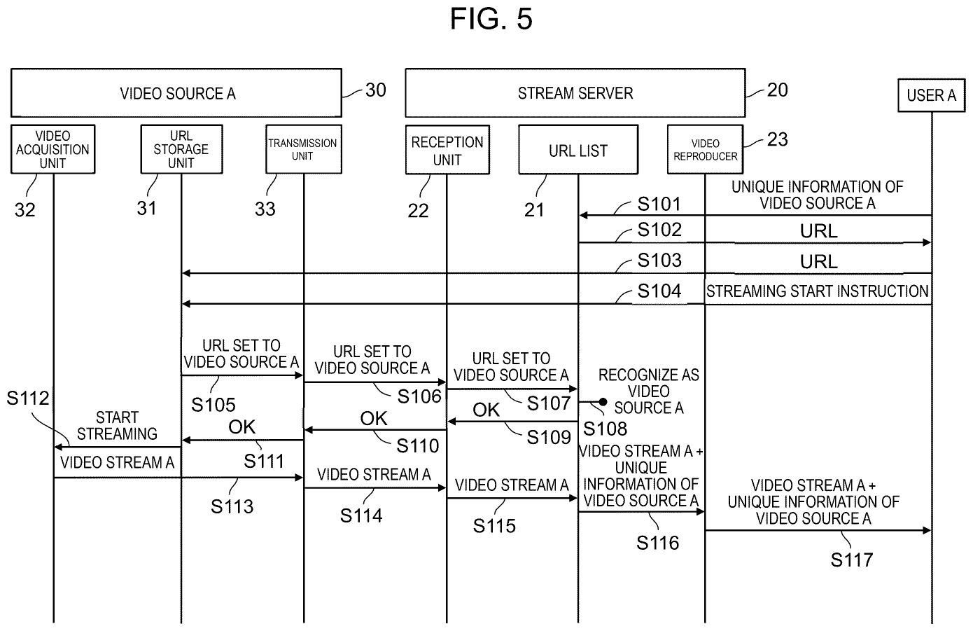

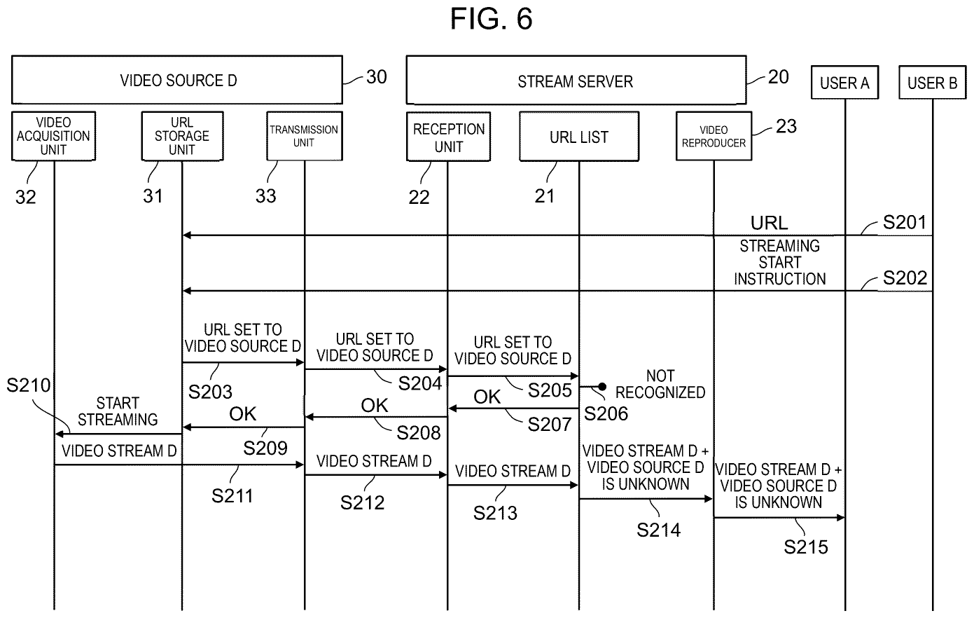

Next, a video stream management method according to the exemplary embodiment will be described with reference to FIGS. 5 and 6.

FIGS. 5 and 6 are sequence diagrams illustrating an example of the video stream management method according to the exemplary embodiment. Note that since the video stream management method is a method executed by video stream management system 1, FIGS. 5 and 6 are also sequence diagrams illustrating an example of the operation of video stream management system 1 according to the exemplary embodiment.

In FIG. 5, user A is illustrated as the user, and video source A is illustrated as video source 30. Video source A is video source 30 grasped by user A.

First, user A inputs unique information of video source A to client device 10, and stream server 20 generates a URL in which the unique information of video source A is described at a predetermined portion, and stores the URL in URL list 21 (step S101).

Stream server 20 transmits the generated URL to client device 10 and displays the URL for user A (step S102).

User A sets the generated URL to video source A by storing the URL in URL storage unit 31 of video source A (step S103). Furthermore, user A instructs video source A to start streaming (step S104).

In order to start streaming, video source A transmits the URL set to video source A to stream server 20 (from step S105 to step S107).

Stream server 20 recognizes that the received URL is the URL set to video source A by collating the received URL with URL list 21 (step S108). In other words, stream server 20 recognizes that the received URL is a URL set to video source A to which unique information (nickname) is added by user A.

Stream server 20 permits establishment of a session with video source A (step S109 to step S111), and video source A starts streaming (step S112).

Video source A transmits video stream A to stream server 20 (from step S113 to step S115).

Stream server 20 receives video stream A, and displays video stream A and unique information of video source A (that is, description of a predetermined portion in the URL set to video source A) on the display device viewed by user A (step S116 and step S117). The unique information of video source A is displayed when it is recognized in step S108 that the URL received from video source A is the URL set to video source A.

Next, in FIG. 6, user A and user B are illustrated as users, and video source D is illustrated as video source 30. Video source D is video source 30 that is not grasped by user A. For example, it is assumed that user B is a user unrelated to user A and intends to distribute video stream D of video source D.

In the example illustrated in FIG. 6, stream server 20 does not generate the URL in which the unique information of video source D is described, and the URL is not stored in URL list 21.

User B stores the URL in URL storage unit 31 of video source D, and sets the URL to video source D (step S201). Furthermore, user B instructs video source D to start streaming (step S202).

In order to start streaming, video source D transmits the URL set to video source D to stream server 20 (from step S203 to step S205).

Stream server 20 collates the received URL with URL list 21, but cannot recognize video source D because the received URL is not in URL list 21 (step S206). In other words, stream server 20 recognizes that the received URL is the URL set to unknown video source 30.

Stream server 20 permits establishment of a session with video source D (from step S207 to step S209), and video source D starts streaming (step S210).

Video source D transmits video stream D to stream server 20 (from step S211 to step S213).

Stream server 20 receives video stream D, and displays that video stream D and the transmission source of video stream D are unknown on the display device viewed by user A (step S214 and step S215). The fact that the transmission source of video stream D is unknown is displayed in a case where the URL received from video source D is not in URL list 21 in step S206.

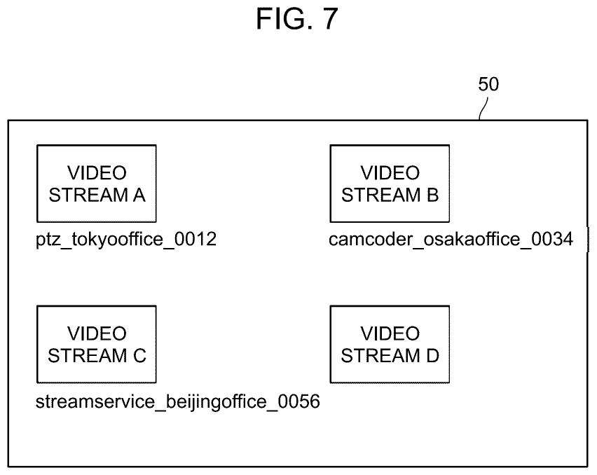

FIG. 7 is a diagram illustrating an example of display screen 50 of a video stream according to the exemplary embodiment. Display screen 50 is, for example, a screen of a display device viewed by the user.

Video streams A, B, and C are video streams transmitted from video source 30 to which a URL included in URL list 21 is set, and video stream D is a video stream transmitted from video source 30 to which a URL not included in URL list 21 is set. For video streams A, B, and C, it can be seen that a description of a predetermined portion in the URL (that is, unique information) is displayed together with the video stream. On the other hand, for video stream D, only the video stream is displayed, and it can be seen that the description of the predetermined portion in the URL is not displayed since the transmission source of video stream D is unknown. As a result, the user can specify the transmission sources of video streams A, B, and C, and can confirm that the transmission source of video stream D is unknown.

For example, the user may be a switcher in a television station or the like, and can refer to the description of a predetermined portion in the URL displayed together with the video stream when selecting the video stream from among video streams A to D. For example, the user can safely select video stream A, B, or C whose transmission source has been specified, and can prevent the user from selecting video stream D whose transmission source is unknown.

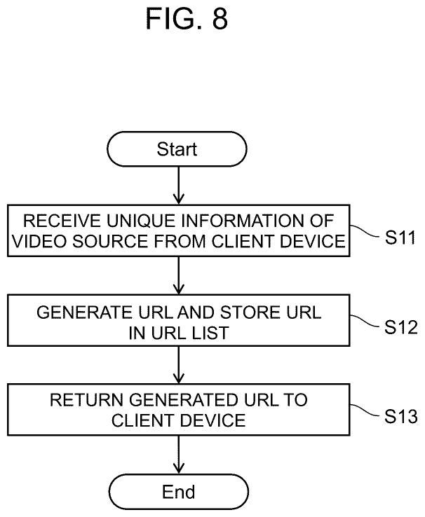

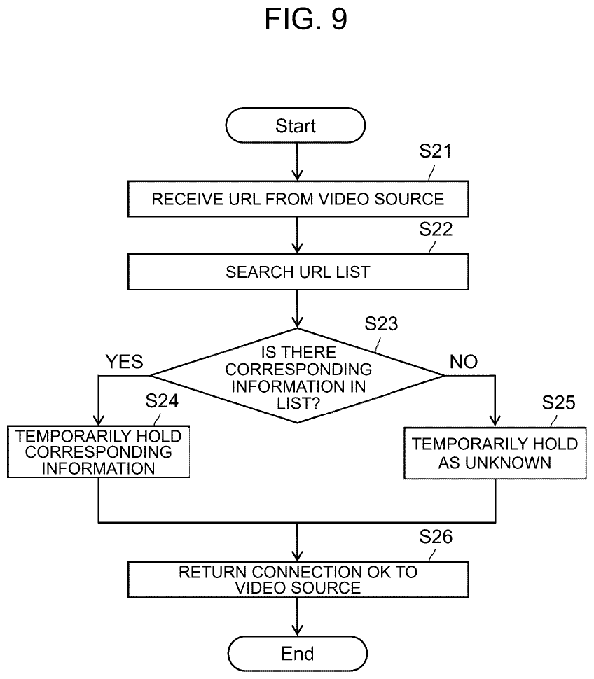

Next, details of the operation of stream server 20 in the embodiment will be described with reference to FIGS. 8 and 9.

FIG. 8 is a flowchart illustrating an example of the operation of stream server 20 according to the exemplary embodiment when accepting URL editing.

First, stream server 20 receives unique information of video source 30 from client device 10 (step S11). For example, as illustrated in FIG. 2, unique information input to client device 10 by the user is transmitted to stream server 20, and stream server 20 acquires the unique information.

Next, stream server 20 describes the acquired unique information in a predetermined portion of the URL set to video source 30, generates a URL in which the predetermined portion is edited, and stores the URL in URL list 21 (step S12). For example, stream server 20 generates a URL as illustrated in FIG. 3.

Then, stream server 20 returns the generated URL to client device 10 (step S13). For example, as shown in FIGS. 4A to 4C, the generated URL is displayed on client device 10, and the user can set the URL to video source 30.

FIG. 9 is a flowchart illustrating an example of the operation of stream server 20 when receiving the URL according to the exemplary embodiment.

First, stream server 20 receives the URL set to video source 30 from video source 30 (step S21).

Next, stream server 20 searches URL list 21 (step S22), and determines whether or not there is information corresponding to the received URL in the list (step S23). The information corresponding to the received URL is, for example, unique information as illustrated in FIG. 3.

When there is the information corresponding to the received URL (Yes in step S23), stream server 20 temporarily stores the information (unique information) corresponding to the received URL (step S24). As a result, it is possible to display the temporarily stored unique information together with the video stream from video source 30 that has transmitted the received URL.

When there is no information corresponding to the received URL (No in step S23), stream server 20 determines that video source 30 that has transmitted the received URL is unknown, and temporarily stores the fact (step S25). As a result, it is possible to display that the transmission source of the video stream is unknown together with the video stream from video source 30 that has transmitted the received URL.

Then, stream server 20 returns connection OK to video source 30 (step S26). In the example described here, regardless of whether or not there is information corresponding to the received URL in URL list 21, stream server 20 establishes a session with video source 30 and distributes the video stream.

As described above, the video stream management method is a method executed by video stream management system 1 that manages a video stream received from video source 30, and the method includes processing of accepting editing of a predetermined portion in a distribution URL set in video source 30, receiving a distribution URL having the predetermined portion edited and the video stream from video source 30, and displaying a description of the predetermined portion together with the video stream.

According to this, the user can edit a predetermined portion in the distribution URL, and can set the distribution URL having the predetermined portion edited to video source 30. Then, when receiving the distribution URL having the predetermined portion edited from video source 30, stream server 20 displays the description of the predetermined portion in the distribution URL together with the video stream. Therefore, the user can specify the transmission source of the video stream by viewing the displayed description of the predetermined portion.

For example, in a case where a distribution URL having a predetermined portion not edited is received, it may be displayed that the transmission source of the video stream is unknown together with the video stream.

Accordingly, the user can confirm that the transmission source of the video stream is unknown.

For example, the description of the predetermined portion may include information unique to video source 30.

Since information unique to video source 30 (for example, a nickname given to the video source by the user) is displayed, the user can specify the transmission source of the video stream by viewing the unique information.

Furthermore, video stream management system 1 is a system that manages a video stream received from video source 30, and the system includes client device 10 that accepts editing of a predetermined portion in a distribution URL set to video source 30, reception unit 22 that receives a distribution URL having the predetermined portion edited and the video stream, and video reproducer 23 that displays a description of the predetermined portion together with the video stream.

Accordingly, it is possible to provide video stream management system 1 in which the user can specify the transmission source of the video stream.

Furthermore, video stream management method is a method executed by stream server 20 that manages the video stream received from video source 30, and the method includes processing of receiving a distribution URL set to video source 30 and the video stream, the distribution URL having a predetermined portion edited, and displaying a description of the predetermined portion together with the video stream.

According to this, it is possible to provide a video stream management method in which a user can specify a transmission source of a video stream.

Furthermore, stream server 20 is a video stream management device that manages a video stream received from video source 30, and the device includes reception unit 22 that receives a distribution URL set to video source 30 and the video stream, the distribution URL having a predetermined portion edited, and video reproducer 23 that displays a description of the predetermined portion together with the video stream.

According to this, it is possible to provide stream server 20 in which the user can specify the transmission source of the video stream.

### Modification of Exemplary Embodiment

In the exemplary embodiment, an example has been described in which stream server 20, when having received a URL having a predetermined portion not edited, receives a video stream from video source 30 to which the URL is set. In a modification of the exemplary embodiment, an example will be described in which when a URL having a predetermined portion not edited is received, a video stream is not received from video source 30 to which the URL is set.

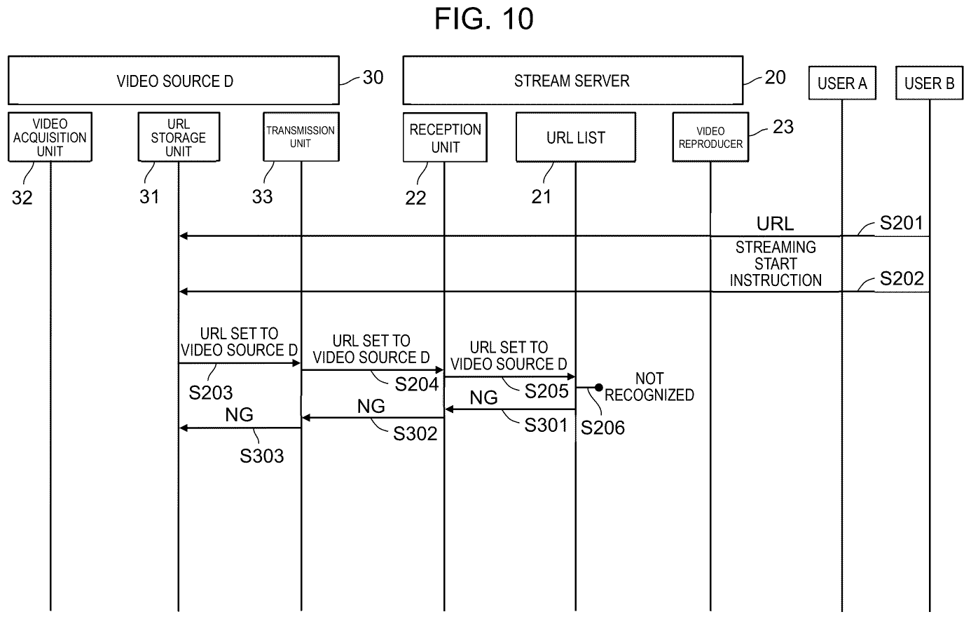

A modification of the exemplary embodiment will be described with reference to FIGS. 10 to 12.

FIG. 10 is a sequence diagram illustrating an example of a video stream management method according to a modification of the exemplary embodiment. Since the processing from step S201 to step S206 is the same as that described in FIG. 6, the description thereof will be omitted.

Stream server 20 does not permit establishment of a session with video source D (steps S301 to S303), and video source D does not start streaming. As described above, stream server 20, when having received a URL having a predetermined portion not edited, does not receive the video stream from video source 30 to which the URL is set.

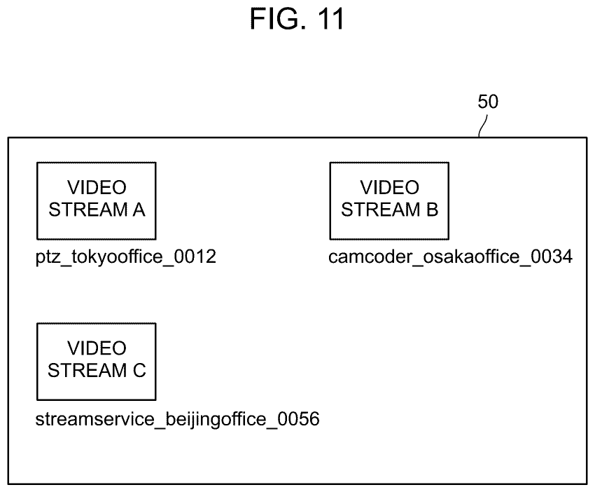

FIG. 11 is a diagram illustrating an example of video stream display screen 50 according to a modification of the exemplary embodiment.

In the exemplary embodiment, as illustrated in FIG. 7, an example has been described in which video stream D transmitted from video source 30 to which a URL not included in URL list 21 is set is also displayed. In the modification of the exemplary embodiment, since stream server 20 does not receive a video stream from video source 30 to which the URL not included in URL list 21 is set, video stream D is not displayed as illustrated in FIG. 11. As a result, it is possible to prevent the user from viewing the video stream of video source 30 whose transmission source is unknown.

For example, the user may be a switcher in a television station or the like, and can prevent video stream D whose transmission source is unknown from being selected.

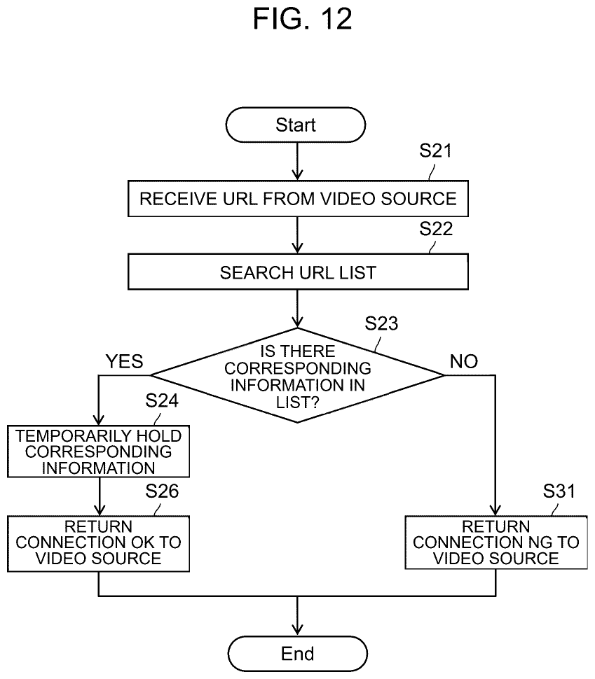

Next, details of the operation of stream server 20 in the modification of the exemplary embodiment will be described with reference to FIG. 12.

FIG. 12 is a flowchart illustrating an example of the operation of stream server 20 when receiving a URL according to the modification of the exemplary embodiment.

Since the processing from step S21 to step S24 and the processing in step S26 are the same as those described in FIG. 9, the description thereof will be omitted.

When there is no information corresponding to the received URL (No in step S23), stream server 20 returns connection NG to video source 30 (step S31). As a result, the video stream from video source 30 that has transmitted the URL that is not in URL list 21 can be prevented from being received, and for example, the communication band can be saved. Furthermore, for example, in a case where a large amount of video streams are to be delivered by a malicious third party, it is possible to prevent the large amount of video streams from being received.

As described above, when the distribution URL having the predetermined portion not edited is received, the video stream may not be received from video source 30 to which the distribution URL has been set.

Accordingly, it is possible to prevent a video stream whose transmission source is unknown from being displayed

### Other Exemplary Embodiments

As described above, the exemplary embodiment and the modification thereof have been described as examples of the technique disclosed in the present application. However, the technique in the present disclosure is not limited thereto, and can also be applied to exemplary embodiments in which changes, replacements, additions, omissions, and the like are appropriately made. Furthermore, it is also possible to make a new exemplary embodiment by combining the constituent elements described in the above exemplary embodiment and the modifications thereof.

For example, the steps included in the video stream management method may be executed by a computer (computer system). The present disclosure can be implemented as a program for causing a computer to execute steps included in these methods. Furthermore, the present disclosure can be implemented as a non-transitory computer-readable recording medium such as a CD-ROM in which the program is recorded.

For example, in a case where the present disclosure is implemented by a program (software), each step is executed by executing the program using hardware resources such as a CPU, a memory, and an input and output circuit of a computer. That is, each step is executed by the CPU acquiring data from a memory, an input and output circuit, or the like and calculating the data, or outputting a calculation result to the memory, the input and output circuit, or the like.

Further, the constituent elements included in video stream management system 1 of the above exemplary embodiments may be implemented as large scale integration (LSI) that is an integrated circuit (IC).

In addition, the integrated circuit is not limited to the LSI, and may be implemented by a dedicated circuit or a general-purpose processor. A programmable field programmable gate array (FPGA) or a reconfigurable processor in which connections and settings of circuit cells inside the LSI are reconfigurable may be used.

Further, when a circuit integration technology replacing the LSI appears due to the progress of the semiconductor technology or another derived technology, naturally, the constituent elements included in video stream management system 1 may be integrated using the technology.

As described above, the exemplary embodiments have been described as examples of the technique in the present disclosure. For this purpose, the accompanying drawings and the detailed description have been provided.

Therefore, the constituent elements described in the accompanying drawings and the detailed description may include not only constituent elements essential for solving the problem but also constituent elements not essential for solving the problem. Therefore, it should not be immediately recognized that these non-essential constituent elements are essential based on the fact that these non-essential constituent elements are described in the accompanying drawings and the detailed description.

In addition, since the above-described exemplary embodiments are intended to illustrate the technique in the present disclosure, various changes, replacements, additions, omissions, and the like can be made within the scope of the claims and equivalents thereof.

### INDUSTRIAL APPLICABILITY

The present disclosure is applicable to a system that distributes a video stream.

### REFERENCE MARKS IN THE DRAWINGS

1 video stream management system
10 client device
11 input field
12, 13, 14 URL display button
15 display field
16 distribution start button
20 stream server
21 URL list
22 reception unit
23 video reproducer
30 video source
31 URL storage unit
32 video acquisition unit
33 transmission unit
50 display screen

1. A video stream management method executed by a video stream management system that manages a video stream received from a video source, the method comprising:
accepting editing of a predetermined portion in a distribution URL set to the video source;
receiving a distribution URL having the predetermined portion edited and the video stream from the video source; and
displaying a description of the predetermined portion together with the video stream.

2. The method according to claim 1, further comprising
when having received a distribution URL having the predetermined portion not edited, displaying that a transmission source of the video stream is unknown together with the video stream.

3. The method according to claim 1, further comprising
when having received a distribution URL having the predetermined portion not edited, not receiving the video stream from the video source to which the distribution URL has been set.

4. The method according to claim 1, wherein the description of the predetermined portion includes information unique to the video source.

5. A video stream management system that manages a video stream received from a video source, the system comprising:
an acceptance unit that accepts editing of a predetermined portion in a distribution URL set to the video source;
a reception unit that receives a distribution URL having the predetermined portion edited and the video stream; and
a display unit that displays a description of the predetermined portion together with the video stream.

6. A video stream management method executed by a video stream management device that manages a video stream received from a video source, the method comprising:
receiving a distribution URL set to the video source and the video stream, the distribution URL having a predetermined portion edited; and
displaying a description of the predetermined portion together with the video stream.

7. A video stream management device that manages a video stream received from a video source, the device comprising:
a reception unit that receives a distribution URL set to the video source and the video stream, the distribution URL having a predetermined portion edited; and
a display unit that displays a description of the predetermined portion together with the video stream.
